(19) United States
(12) Patent Application Publication
(10) Pub. No.: US 2024/0336185 A1
(43) Pub. Date: Oct. 10, 2024

(54) SOLAR COMPONENT STORAGE AND DISTRIBUTION DEVICES

(71) Applicant: ARRAY TECH, INC., Albuquerque, NM (US)

(72) Inventors: Nathan Schuknecht, Golden, CO (US); Nathan Stegall, Chandler, AZ (US); Chris Rowland, Chandler, AZ (US); Michael Corio, Chandler, AZ (US); Jonathan Drake, Chandler, AZ (US)

(21) Appl. No.: 18/748,640

(22) Filed: Jun. 20, 2024

Related U.S. Application Data
(63) Continuation of application No. 18/495,694, filed on Oct. 26, 2023.
(60) Provisional application No. 63/381,108, filed on Oct. 26, 2022.

(51) Int. Cl. B60P 1/02; B60P 1/52; B60P 3/00; B66F 7/06

(52) U.S. Cl. CPC B60P 1/02; B60P 1/52; B60P 3/002; B60P 1/025; B66F 7/065

(57) ABSTRACT

A photovoltaic (PV) module distribution device may include a platform and an installation arm. The platform may be configured to store a plurality of PV modules in a pre-determined orientation. Each of the PV modules may include solar components that are pre-assembled to form a corresponding PV module. The installation arm may be configured to retrieve a PV module of the plurality of PV modules from the platform. The installation arm may also be configured to position the PV module proximate a support column physically located proximate the PV module distribution device to permit a user to attach the PV module to the support column.

### CROSS-REFERENCE TO RELATED APPLICATION

This patent application is a continuation of U.S. patent application Ser. No. 18/495,694 filed Oct. 26, 2023, titled “SOLAR COMPONENT STORAGE AND DISTRIBUTION DEVICES”, which is incorporated in the present disclosure by reference in its entirety, and which claims the benefit of and priority to U.S. Provisional App. No. 63/381,108 filed Oct. 26, 2022, titled “SOLAR POWER SYSTEM INSTALLATION SYSTEMS”, which is incorporated in the present disclosure by reference in its entirety.

### FIELD

The embodiments discussed in the present disclosure are related to storage and distribution devices for solar components.

### BACKGROUND

Unless otherwise indicated in the present disclosure, the materials described in the present disclosure are not prior art to the claims in the present application and are not admitted to be prior art by inclusion in this section.

Construction of a large-scale solar installation may include distributing solar components such as photovoltaic (PV) panels, torque tubes, mounting brackets, torque tube interfaces, support columns, or any other appropriate solar component over a large landmass. The distribution process may include placing given solar components at a given installation site within the large landmass. In addition, the construction of the large-scale solar installation may include installers physically moving, assembling, and/or installing the solar components at the installation site.

Due to the large number of solar components within a typical solar installation, physically moving, assembling, and/or installing the solar components at the installation site may be physically taxing for the installers and can add time to the installation process. In addition, the large number of solar components makes the distribution process and/or the installation process complex. Therefore, construction of the large-scale solar installation may be logistically intensive, labor intensive, and time intensive.

Accordingly, there is a need for an improved system for distributing and/or installing the solar components of the large-scale solar installation.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Embodiments of the present disclosure include distribution devices that facilitate the distribution and/or the installation of solar components to address some of the problems discussed above. The distribution devices may facilitate movement of the solar components between a loading site and an installation site, within an installation site, or both. In addition, the distribution devices may facilitate the installation of the solar components at the installation site by positioning the solar components relative to previously installed solar components to assist installers couple the solar components to other solar components.

One embodiment includes a PV panel distribution device that facilitates distribution and/or installation of the PV panels. The installation process may include coupling individual PV panels to support columns at a given installation site, either directly or via torque tubes using mounting brackets, mounting rails, torque tube interfaces, or both. The PV panel distribution device may sequentially position individual PV panels relative to a given torque tube to permit the installers (e.g., users) to be in upright positions when retrieving the individual PV panels to couple the PV panels to other solar components. The PV distribution device may permit the installers to receive and install the PV panels without picking the PV panels up from a ground surface, removing the PV panels from a crate, or bending in general. Thus, the PV distribution device may reduce the risk of injury to or physical fatigue of the installers during construction of the solar installation.

In some embodiments, the PV panel distribution device may include a transportation device configured to move within the installation site, between a loading site and the installation site, or both to facilitate distribution of the PV panels. For example, the transportation device may move within the installation site to permit the different PV panels to be positioned relative to different sections of the given torque tube. As another example, the transportation device may move between the loading site and the installation site to distribute the PV panels at the installation site and to receive additional PV panels for distribution at the loading site. In some embodiments, the PV panel distribution device may include a trailer configured to be coupled to a vehicle and the vehicle may move the PV panel distribution device between the loading site and the installation site. In other embodiments, the PV panel distribution device may include the trailer and the vehicle as a single body vehicle configured to move between the loading site and the installation site.

Other embodiments include a PV module distribution device that facilitate distribution and/or installation of PV modules within the solar installation. In some embodiments, at least some of the solar components may be pre-assembled to form a PV module and the PV module distribution device may distribute the PV module at the installation site. The PV module may include one or more solar panels coupled to a given torque tube via mounting rails, the torque tube coupled to a torque tube interface, mounting brackets coupled to the torque tube interface, or any other combination of solar components coupled to each other. The installation process may include attaching the PV module to a given support column and/or a different PV module at the installation site to install the PV module in the solar installation, which the PV module distribution device is configured to assist with.

The PV module distribution device may include one or more installation arms configured to retrieve a given PV module from a platform of the PV module distribution device. The PV module distribution device may then position the PV module relative to the support column and release the PV module responsive to the installers attaching the PV module to the support column. The PV module distribution device may move and repeat this process to permit different PV modules to be positioned relative to and attached to different support columns. Thus, the PV module distribution device may reduce the complexity for distributing the solar components, by permitting the solar components to be assembled remotely to form the PV module and then distributed as the PV module at the installation site rather than being distributed as individual solar components.

Thus, the disclosed embodiments reduce logistical complexity, the amount of labor, the amount of time, or some combination thereof to distribute and install solar components in the solar installation by positioning, which may reduce the complexity and/or cost of constructing the solar installation.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example PV panel distribution device distributing PV panels for installation within a solar installation;

FIGS. 2A and 2B illustrate a perspective view and a front view, respectively, of the example PV panel distribution device and a transportation device of FIG. 1;

FIGS. 3A-3C illustrate the example PV panel distribution device of FIG. 1 with a movement mechanism in different states to move an example PV panel from an initial removal position to a final removal position;

FIGS. 4A and 4B illustrate the example PV panel distribution device of FIG. 1 including an elevating system in different states to move the PV panels within a volume of the PV panel distribution device;

FIG. 5 illustrates multiple PV panel distribution devices and multiple transportation devices coupled to each other to form an example delivery train;

FIGS. 6A and 6B illustrate different example arrangement of PV panel distribution devices and a transportation device to form example delivery trains;

FIG. 7 illustrates an example PV module distribution device distributing PV modules for installation within a solar installation;

FIGS. 8A and 8B illustrate a right perspective view and a left perspective view, respectively, of the example PV module distribution device of FIG. 7;

FIGS. 9A and 9B illustrate a right perspective view and a left perspective view, respectively, of another example PV module distribution device;

FIGS. 10A-10C illustrate the PV module distribution device of FIGS. 9A and 9B with installation arms in different positions to remove a PV module from a platform of the PV module distribution device and position the PV module in an installation position;

FIG. 11 illustrates another example PV module distribution device; and

FIG. 12 illustrates yet another example PV module distribution device;

all according to at least one embodiment described in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

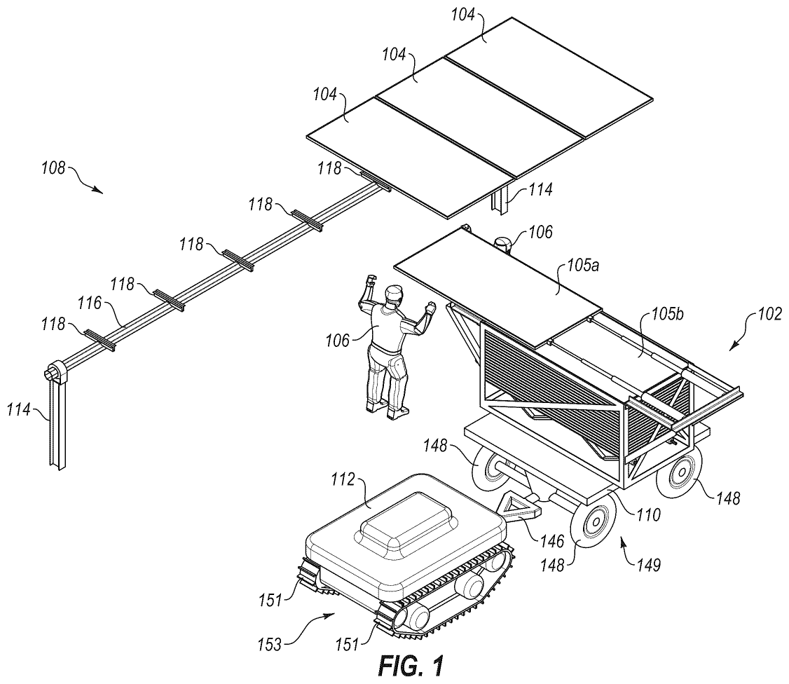

Referring to FIG. 1, an example PV panel distribution device 102 (generally referred to in the present disclosure as distribution device 102) distributing PV panels 105a-b at an installation site is shown. As shown in FIG. 1, a solar installation 108 includes PV panels 104 that are coupled to a torque tube 116 via mounting rails 118. In addition, as shown in FIG. 1, the torque tube 116 is coupled to support columns 114. In FIG. 1, three PV panels 104 are shown as already being coupled to the torque tube 116 with additional mounting rails 118 already coupled to the torque tube 116. The additional mounting rails 118 may permit the PV panels 105a-b and additional PV panels to be installed in the solar installation 108.

The distribution device 102 may store and/or position the PV panels 105a-b to facilitate distribution of the PV panels 105a-b within the installation site and/or installation of the PV panels 105a-b in the solar installation 108. In FIG. 1, only two instances of the PV panels 105a-b to be installed are numbered for ease of illustration. The PV panels 105a-b may be the same as or similar to the PV panels 104 that are already coupled to the torque tube 116 except that the PV panels 105a-b are yet to be installed in the solar installation 108.

In some embodiments, the distribution device 102 may include a transportation device 110 configured to move within the installation site, between a loading site (not illustrated) and the installation site, or both. The transportation device 110 may move the distribution device 102 and the PV panels 105a-b within the installation site, between the loading site and the installation site, or both.

The transportation device 110 may be coupled to a vehicle 112 that moves the transportation device 110 to position the distribution device 102 and the PV panels 105a-b relative to the torque tube 116. The distribution device 102 may move the PV panels 105a-b to cause the PV panel 105a to move to an initial removal position. The distribution device 102 may move the PV panel 105a in another direction to move the PV panel 105a from the initial removal position to a final removal position. The PV panel 105a is shown in FIG. 1 in the final removal position.

Users 106 may retrieve the PV panel 105a from the final removal position and position the PV panel 105a proximate two or more mounting rails 118. The users 106 may couple the PV panel 105a to the two or more mounting rails 118 to install the PV panel 105a in the solar installation 108. For example, the users 106 may position the PV panel 105a next to the left most PV panel 104 shown in FIG. 1 and couple the PV panel 105a to the corresponding two or more mounting rails 118 to install the PV panel 105a in the solar installation 108.

In the final removal position, the users 106 can retrieve the PV panel 105a while being in upright positions. The upright positions may include positions in which the users 106 are standing upright or otherwise positioned such that legs, backs, hips, or some combination thereof of the users 106 are aligned substantially straight or in substantially straight positions. In other words, the upright positions may include positions that reduce or avoid bending at the waist, knees, or ankles by the users 106.

After removal of the PV panel 105a, the vehicle 112 may move the transportation device 110 to position the distribution device 102 and the PV panel 105b relative to a different section of the torque tube 116. The distribution device 102 may repeat the process described above, but with respect to the PV panel 105b instead of the PV panel 105a. The vehicle 112 may move the transportation device 110 to position the distribution device 102 and the PV panels to be installed to permit the users 106 to sequentially install the PV panels to be installed in the solar installation 108.

The distribution device 102 is illustrated in FIG. 1 as being positioned on the transportation device 110 as an example. The distribution device 102 may be in any other appropriate position. For example, the distribution device 102 with the PV panels to be installed may be placed on a ground surface or other device at the installation site.

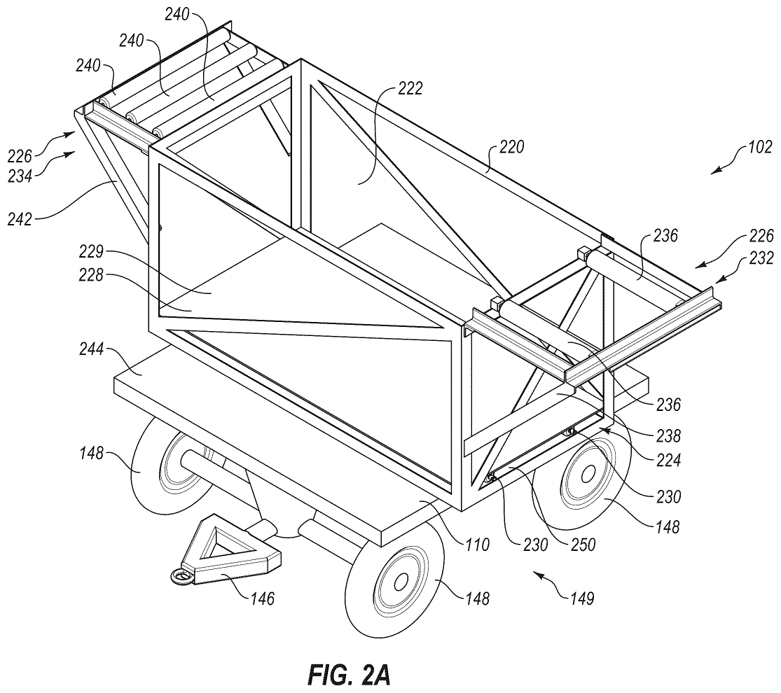

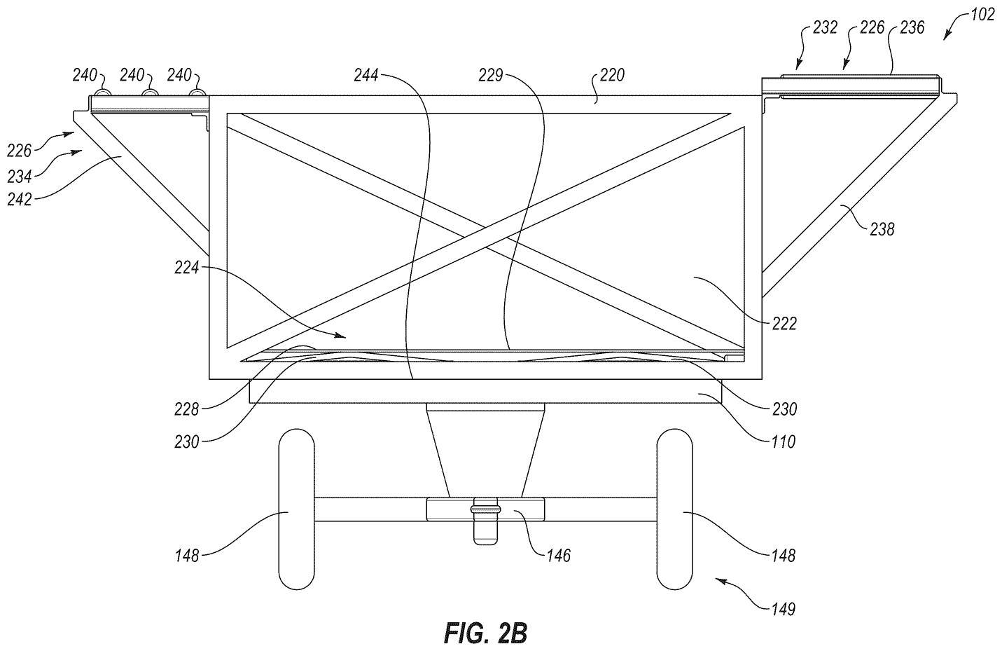

With combined reference to FIGS. 1-2B, the distribution device 102 may include a housing assembly 220 configured to store the PV panels 105a-b. The housing assembly 220 may be configured to store the PV panels 105a-b in a predetermined orientation within a volume 222 defined by the housing assembly 220. In some embodiments, the housing assembly 220 may store the PV panels 105a-b in a horizontal orientation such that a length and a width of the PV panels 105a-b extend substantially parallel to the ground surface or a platform surface 244 of the transportation device 110. The housing assembly 220 is illustrated in FIG. 1 as storing the PV panels 105a-b in a horizontal orientation for example purposes. The housing assembly 220 may be configured to store the PV panels 105a-b in other orientations such as a vertical orientation or a diagonal orientation.

With combined reference to FIGS. 1-3C, the distribution device 102 may include a movement mechanism 226 configured to apply a force to the PV panel 105a in the initial removal position to cause the PV panel 105a to move to a final removal position to permit the users 106 to retrieve the PV panel from the final removal position.

As shown, the movement mechanism 226 includes an extension system 232 that includes extending arms 236. The extension system 232 may also include a mounting bracket 238 coupled to the extending arms 236 and a first side of the housing assembly 220. The extending arm 236 may apply a force to the PV panel 105a in the initial removal position to cause the PV panel 105a to move from the initial removal position to the final removal position. The extension system 232 is shown as including the extending arms 236 for example purposes. However, the extension system 232 may include any appropriate device configured to apply a force to the PV panel 105a to cause the PV panel 105a to move from the initial removal position to the final removal position.

In some embodiments, the extending arm 236 may cause the PV panel 105a to move in a horizontal direction, which may include a direction substantially parallel to a length of the PV panel 105a. Alternatively, the horizontal direction may include a direction that the is substantially parallel to the ground surface or the platform surface 244.

In addition, as shown, the movement mechanism 226 includes a conveyor system 234 that includes rolling devices 240. The movement mechanism 226 may also include a mounting bracket 242 coupled to the rolling devices 240 and a second side of the housing assembly 220. The rolling device 240 may engage with the PV panel 105a to facilitate movement of the PV panel 105a from the initial removal position to the final removal position. For example, the rolling device 240 may engage with a surface of the PV panel 105a and rotate to facilitate movement of the PV panel 105a. The conveyor system 234 is shown as including the rolling devices 240 for example purposes. However, the conveyor system 234 may include any appropriate device configured to engage with the PV panel 105a to facilitate movement of the PV panel 105a.

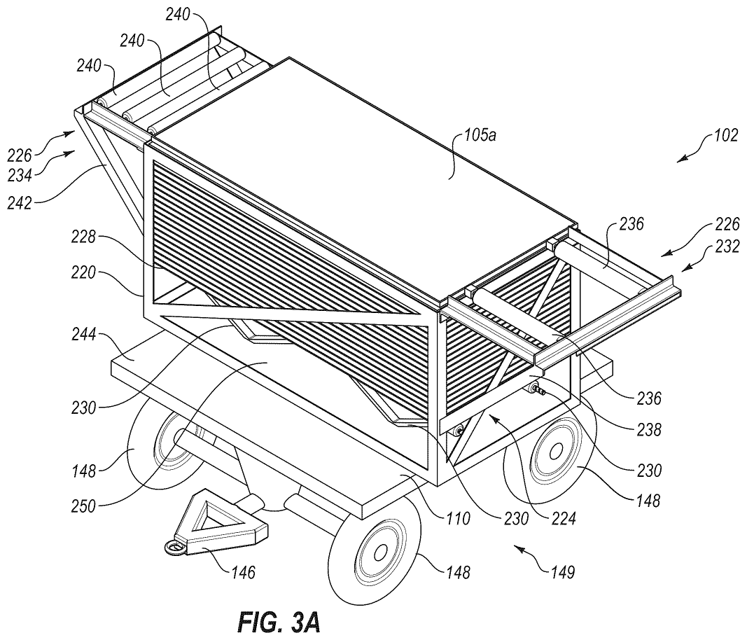

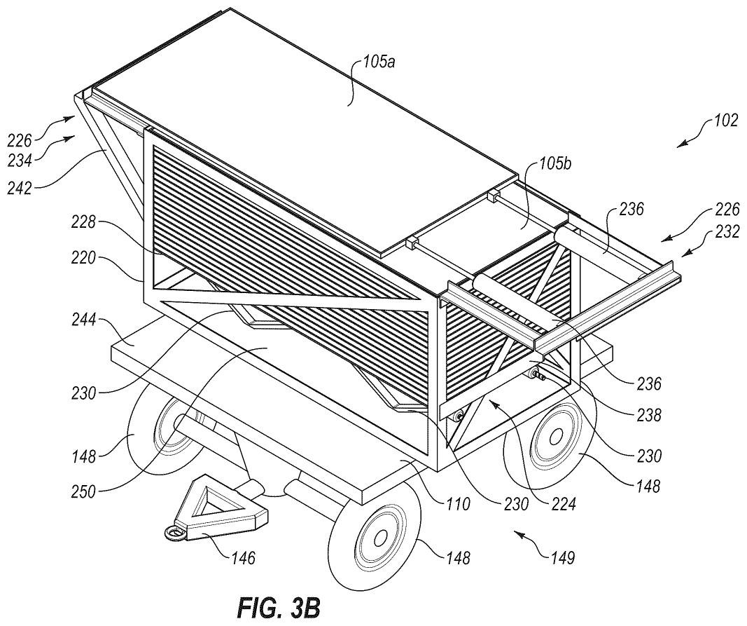

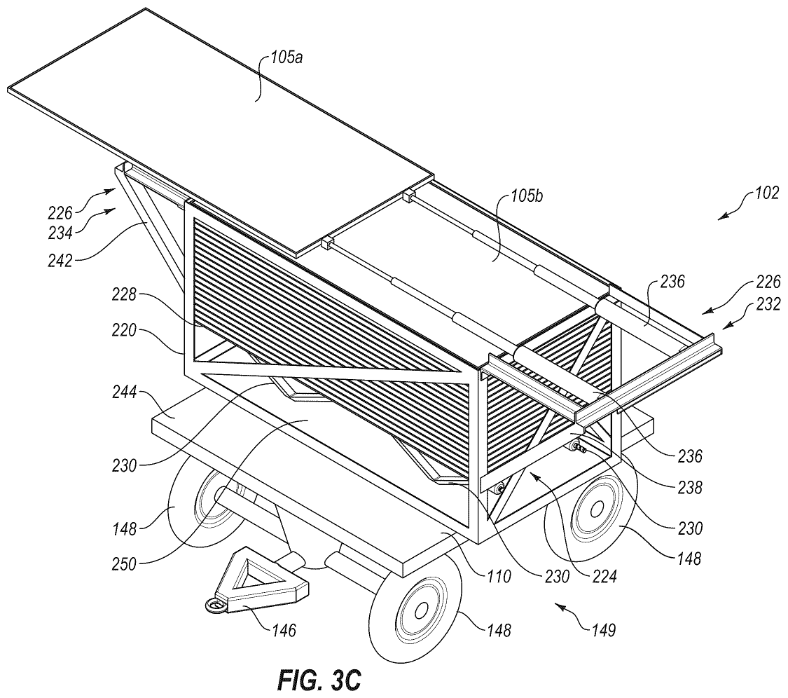

With reference to FIGS. 3A-3C the movement mechanism 226 is shown in different states moving the PV panel 105a from the initial removal position to the final removal position. The movement mechanism 226 is shown in an initial state in FIG. 3A and the PV panel 105a is shown in the initial removal position in FIG. 3A. In the initial state, the extending arm 236 may be retracted and an internal portion of the extending arm 236 may be positioned within an external portion of the extending arm 236. In the initial state, the extending arm 236 may interface with a side of the PV panel 105a while the PV panel 105a is in the initial removal position. Alternatively, in the initial state, the extending arm 236 may be proximate the side of the PV panel 105a while the PV panel 105a is in the initial removal position to form a gap between the extending arm 236 and the PV panel 105a.

The movement mechanism 226 is shown in an intermediate state in FIG. 3B. In the intermediate state, the extending arm 236 may be at least partially extended such that at least a part of the internal portion extends beyond the external portion and along at least a portion of a length of the volume 222. In addition, during the transition from the initial state to the intermediate state, the extending arm 236 may interface with the side of the PV panel 105a to cause the PV panel 105a to move from the initial removal position to an intermediate removal position. In addition, during the transition from the initial state to the intermediate state, the extending arm 236 may interface with the side of the PV panel 105a to cause the PV panel 105a to move towards the conveyor system 234 such that the PV panel 105a engages with the conveyor system 234.

The movement mechanism 226 is shown in a final state in FIG. 3C. In the final state, the extending arm 236 may be at least partially extended such that at least a part of the internal portion extends beyond the external portion and along a greater portion of the length of the volume 222. In addition, during the transition from the intermediate state to the final state, the extending arm 236 may cause the PV panel 105a to move from the intermediate removal position to the final removal position. In addition, during the transition from the intermediate state to the final state, the extending arm 236 may continue to interface with the side of the PV panel 105a to continue to cause the PV panel 105a to move towards the conveyor system 234 and such that the PV panel 105a continues to engage with the conveyor system 234.

In some embodiments, at least a portion of the PV panel 105a extends beyond the conveyor system 234 while in the final removal position as shown in FIG. 3C. Alternatively, at least a portion of the conveyor system 234 may extend beyond the PV panel 105a or an end of the PV panel 105a and the conveyor system 234 may be flush while the PV panel 105a is in the final removal position.

After transitioning to the final state, the extending arm 236 may automatically retract to the initial state. Alternatively, after transitioning to the final state, the extending arm 236 may stay in the final state until an external event occurs. The external event may include the PV panel 105a being retrieved by the users 106, an instruction being received by the distribution device 102, or any other appropriate external event.

The movement mechanism 226 may transition between the initial state, the intermediate state, or the final state based on corresponding instructions. For example, the distribution device 102 may receive an extend instruction and in response, the movement mechanism 226 may transition from the initial state to the intermediate state or the final state. As another example, the distribution device 102 may receive a retract instruction and in response, the movement mechanism 226 may transition from the final state to the intermediate state or to the initial state or from the intermediate state to the initial state. In some embodiments, the distribution device 102 may receive the instructions from a remote control operated by the users 106.

With combined reference to FIGS. 1-4B, the distribution device 102 may include an elevating system 224 configured to engage the PV panels 105a-b within the volume 222 to move the PV panels 105a-b in a direction within the volume 222 so as to position the PV panels 105a-b in the initial removal position. In some embodiments, the initial removal position may be external to the volume 222. In other embodiments, the initial removal position may be proximate an edge of the volume 222.

As shown, the elevating system 224 includes a plate 228 and lift devices 230. The plate 228 may include a first surface 229 configured to interface with the PV panels 105a-b. The lift device 230 may be configured to interface with the plate 228 and a bottom surface 250. The bottom surface 250 may include a bottom section of the housing assembly 220, another plate of the elevating system 224 within the volume 222, the ground surface, the platform surface 244, or any other appropriate surface. The lift device 230 is illustrated as a scissor jack for example purposes. However, the lift device 230 may include any appropriate lift device or jack device. For example, the lift device 230 may include a bottle jack.

The lift device 230 may extend and contract between the bottom surface 250 and the plate 228 so as to move the plate 228 within the volume 222. The lift device 230 may cause the plate 228 to move within the volume 222 to cause the PV panels 105a-b to move to the initial removal position one at a time. In some embodiments, the lift device 230 may move the plate 228 in a substantially vertical direction within the volume 222 to cause the PV panels 105a-b to also move in a substantially vertical direction. The vertical direction may include a direction substantially normal to the ground surface or the platform surface 244.

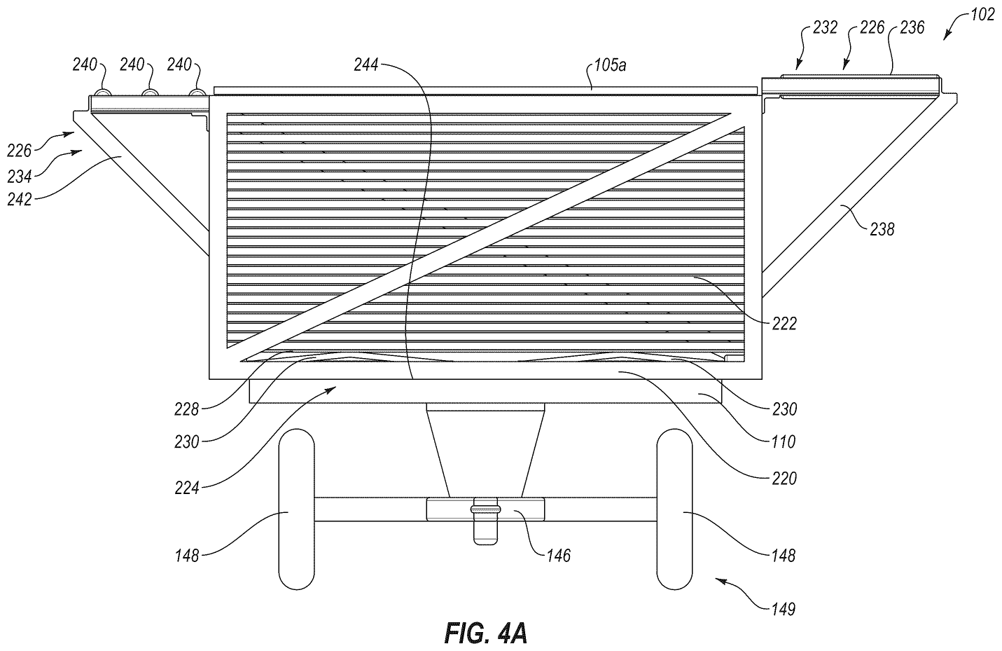

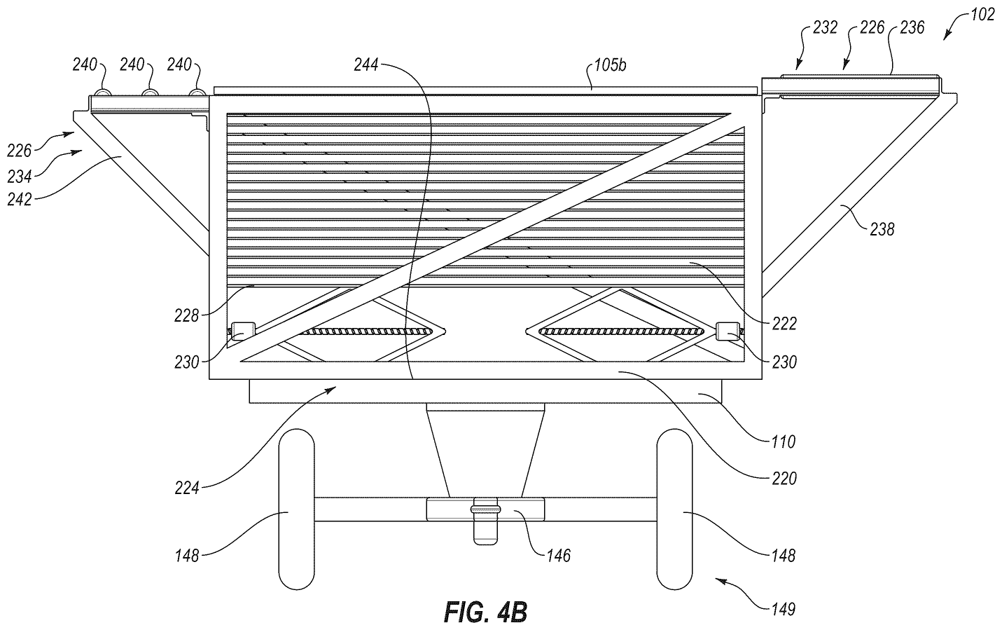

With reference to FIGS. 4A and 4B, the elevating system 224 is shown in different states moving the PV panels 105a-b with the volume 222 or to the initial removal position. The elevating system 224 is shown in an at least partially lowered state in FIG. 4A and the PV panel 105a is shown in the initial removal position in FIG. 4A. In the lowered state, the lift device 230 may be at least partially retracted and the plate 228 may be at least partially lowered within the volume 222. With the plate 228 at least partially lowered, the volume 222 may be able to store more PV panels compared to when the plate 228 is raised. In the lowered state, the plate 228 may position the PV panels such that the PV panel 105a is in the initial removal position.

The elevating system 224 is shown in an at least partially raised state in FIG. 4B and the PV panel 105b is shown in the initial removal position in FIG. 4B. Prior to transitioning to the at least partially raised state, the PV panel 105a may be retrieved and installed in the solar installation 108 or otherwise removed from the distribution device 102. In the raised state, the lift device 230 may be at least partially extended and the plate 228 may be at least partially raised within the volume 222. With the plate 228 at least partially raised, the volume 222 may be able to store fewer PV panels compared to when the plate 228 is lowered. In the raised state, the plate 228 may position the PV panels such that the PV panel 105b is in the initial removal position.

The elevating system 224 may transition between the lowered states and the raised states based on corresponding instructions. For example, the distribution device 102 may receive a lift instruction and in response, the elevating system 224 may transition from a lowered state to a raised state. As another example, the distribution device 102 may receive a lower instruction and in response, the elevating system 224 may transition from a raised state to a lowered state. In some embodiments, the distribution device 102 may receive the instructions from a remote control operated by the users 106.

With reference to FIGS. 1-4B, the transportation device 110 may include a hitch portion 146 configured to couple to the vehicle 112. In some embodiments, the vehicle 112 may include a trailer hitch (not illustrated) configured to interface with the hitch portion 146 to couple the transportation device 110 to the vehicle 112. In addition, the transportation device 110 may include a drive system 149. As shown in FIGS. 1-4B, the drive system 149 includes wheels 148. However, the drive system 149 may include other drive devices such as one or more tracks.

With reference to FIG. 1, the vehicle 112 as shown includes a drive system 153 that includes tracks 151. However, the drive system 153 may include wheels. The transportation device 110 and the vehicle 112 are shown in FIG. 1 as separate devices for example purposes. Alternatively, the transportation device 110 and the vehicle 112 may form a single body vehicle. The vehicle 112, the transportation device 110, or both may operate autonomously or semi-autonomously to position the PV panels to be installed within the installation site or move between the loading site and the installation site.

With continued reference to FIG. 1, the vehicle 112, the transportation device 110, or both may include a position detection system (not illustrated). The position detection system may detect a position of the vehicle 112, the transportation device 110, or both during movement. In some embodiments, the position detection system may detect the position of the vehicle 112, the transportation device 110, or both relative to a most recently installed PV panel 104. Alternatively, the position detection system may detect the position of the vehicle 112, the transportation device 110, or both relative to the torque tube 116, the support columns 114, or any other appropriate solar component or landmark. The position detection system may provide an alert indicating that the vehicle 112, the transportation device 110, or both are positioned relative to a subsequent location corresponding to where another PV panel is to be installed.

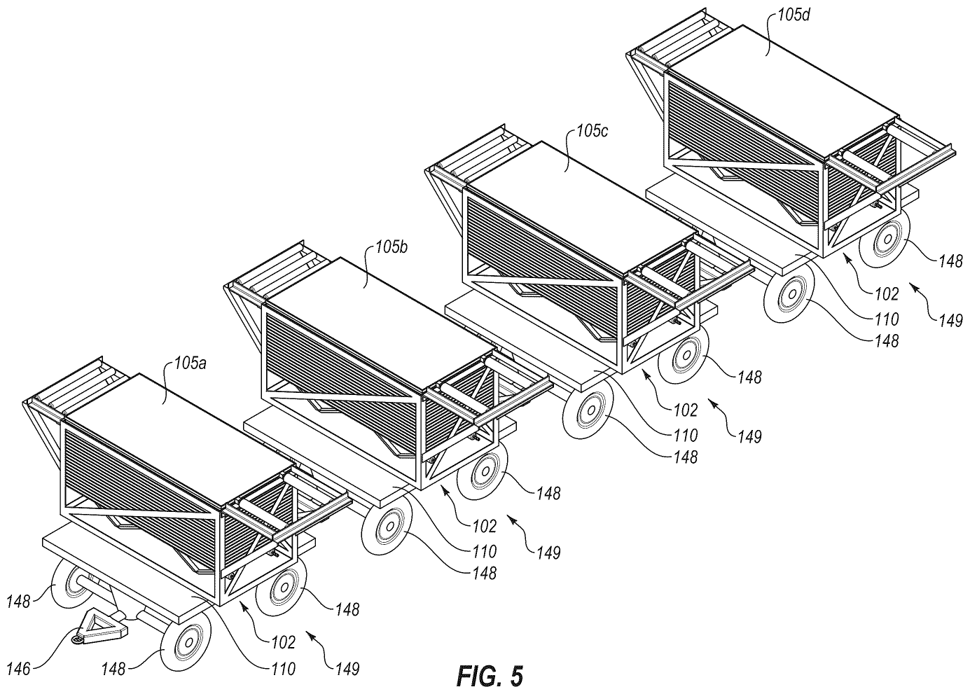

FIG. 5 illustrates multiple distribution devices 102 and multiple transportation devices 110 forming an example delivery train. The transportation devices 110 may be coupled to each other via corresponding hitch portions 146 and corresponding trailer hitches (not shown). The delivery train may permit multiple PV panels 105a-d to be sequentially positioned and installed in a solar installation. Each of the distribution devices 102 when positioned properly, may cause the corresponding one of the PV panels 105a-d to move to the final removal position relative to the corresponding distribution device 102. The transportation devices 110 may move within the installation site to permit the PV panels 105a-d to be installed sequentially along a corresponding torque tube by the users 106.

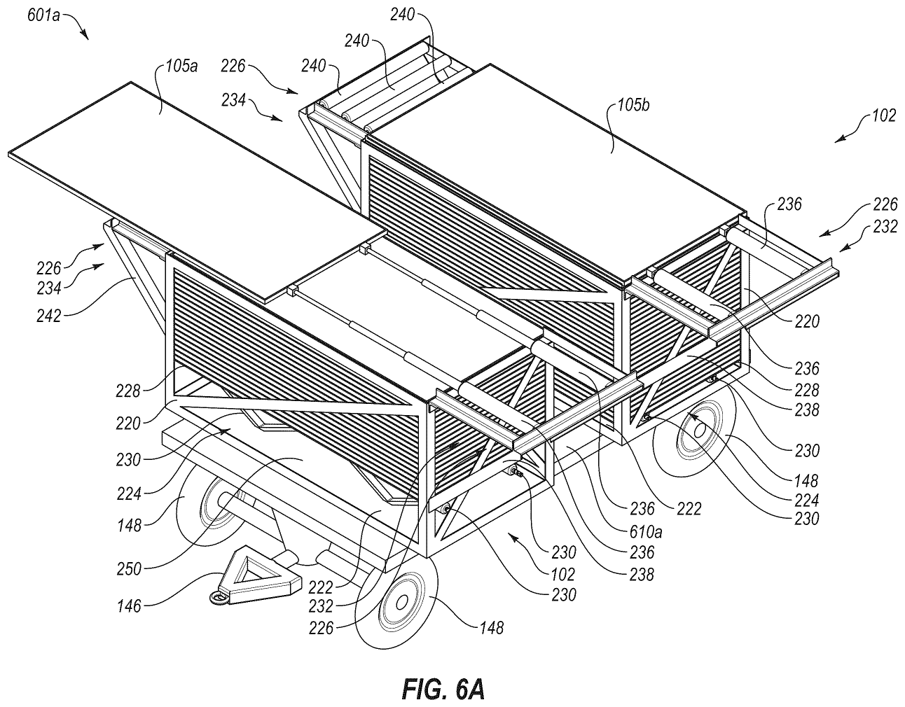

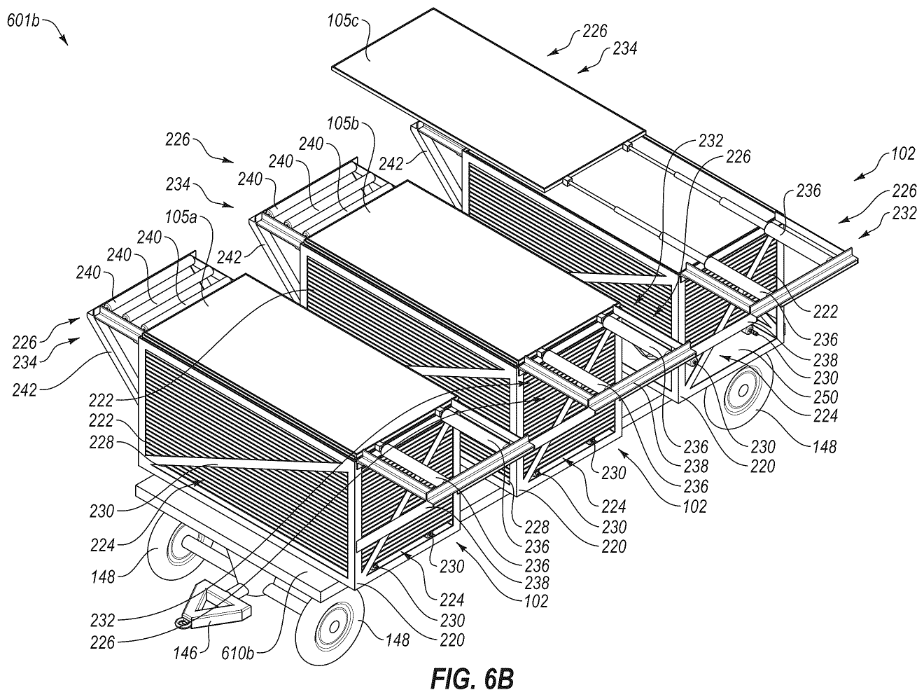

FIGS. 6A and 6B illustrate different example arrangements of multiple distribution devices 102 on transportation device 610a-b to form example distribution systems 601a-b. FIG. 6A illustrates two distribution devices 102 positioned on the transportation device 610a. The distribution system 601a illustrated in FIG. 6A may permit multiple PV panels 105a-b to be sequentially positioned and installed in a solar installation. Each of the distribution devices 102 when positioned properly, may cause the corresponding PV panel 105a-b to move to the final removal position relative to the corresponding distribution device 102. The transportation device 610a may move within the installation site to permit additional PV panels to be installed along a corresponding torque tube by the users 106.

FIG. 6B illustrates three distribution devices 102 positioned on the transportation device 610b. The distribution system 601b illustrated in FIG. 6B may permit multiple PV panels 105a-c to be sequentially positioned and installed in a solar installation. Each of the distribution devices 102 when positioned properly, may cause the corresponding PV panel 105a-c to move to the final removal position relative to the corresponding distribution device 102. The transportation device 610b may move within the installation site to permit additional PV panels to be installed sequentially along a corresponding torque tube by the users 106.

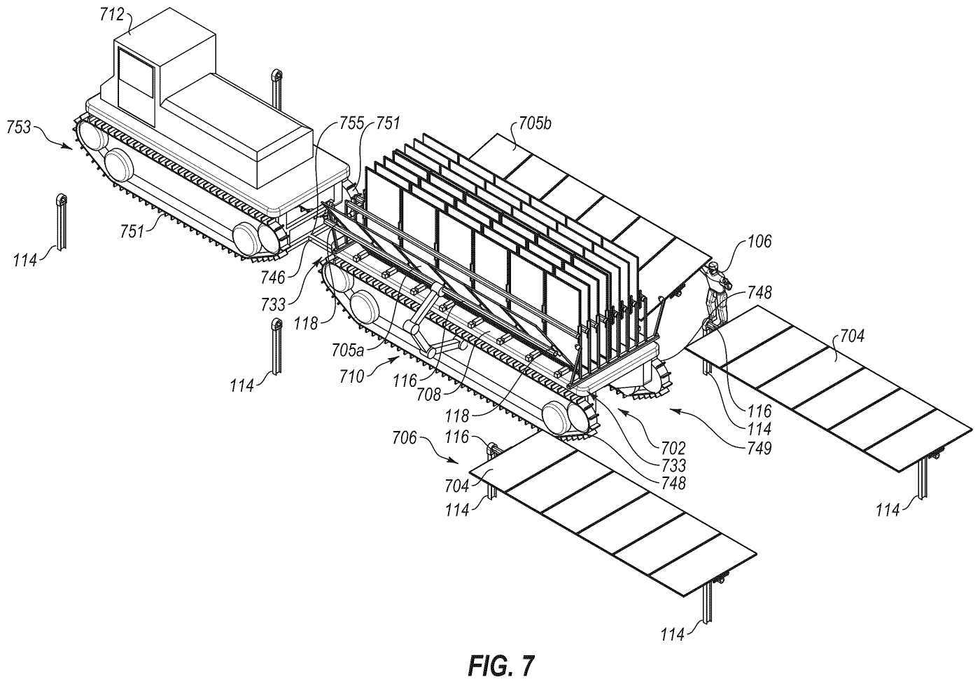

FIG. 7 illustrates an example PV module distribution device 702 (generally referred to in the present disclosure as distribution device 702) distributing PV modules 705a-b at an installation site of a solar installation 706. As shown in FIG. 7, the solar installation 706 may include PV modules 704 that are coupled to the support columns 114 via the torque tubes 116 and the mounting rails 118. In FIG. 7, two PV modules 704 are shown as already being coupled to the support columns 114. The additional support columns 114 may permit the PV modules 705a-b and additional PV modules to be installed in the solar installation 706.

In some embodiments, the PV modules 704 or 705a-b may include multiple solar components that are assembled (e.g., coupled to each other) remote to the installation site. For example, the solar components may be assembled at a centralized assembly factory remote to the installation site to form the PV modules 704 or 705a-b. As another example, the solar components may be assembled at a loading site proximate to the installation site to form the PV modules 704 or 705a-b. The solar components that are pre-assembled to form the PV modules 704 or 705a-b may include one or more solar panels coupled to a given torque tube 116 via given mounting rails 118, the torque tube 116 coupled to a torque tube interface, mounting brackets coupled to the torque tube interface, or any other combination of solar components that are coupled to each other. As shown in FIG. 7, the PV modules 704 or 705a-b include six PV panels coupled to given torque tubes 116 via given mounting rails 118.

The distribution device 702 may store and/or position the PV modules 705a-b to facilitate distribution of the PV modules 705a-b within the installation site and/or facilitate installation of the PV modules 705a-b in the solar installation 706. In FIG. 7, only two instances of the PV modules 705a-b to be installed are numbered for ease of illustration. The PV modules 705a-b may be the same as or similar to the PV modules 704 that are already coupled to the support columns 114 except that the PV modules 705a-b are yet to be installed in the solar installation 706.

The distribution device 702 may be coupled to a vehicle 712 that moves the distribution device 702 to position the PV modules 705a-b relative to the support columns 114. The distribution device 702 may position the PV modules 705a-b so as to permit the PV modules 705a-b to be coupled to the support columns 114.

In some embodiments, a user 106 may guide the distribution device 702 such that the PV module 705a is positioned proximate one or more of the support columns 114, another torque tube 116, or both to permit the user 106 to couple the PV module 705a to the support columns 114, the other torque tube, or both to install the PV module 705a in the solar installation 706.

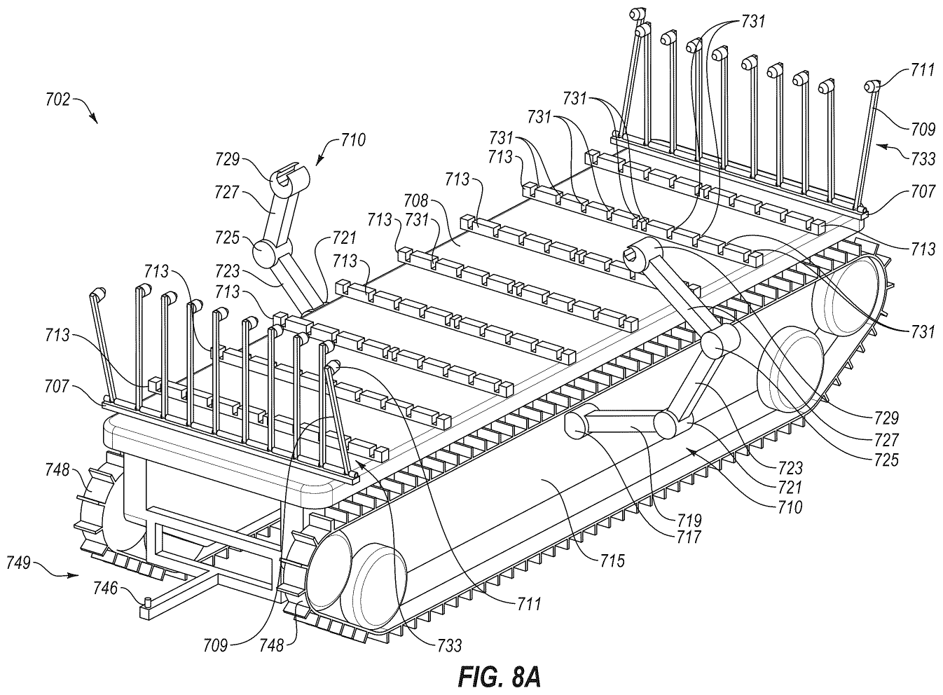

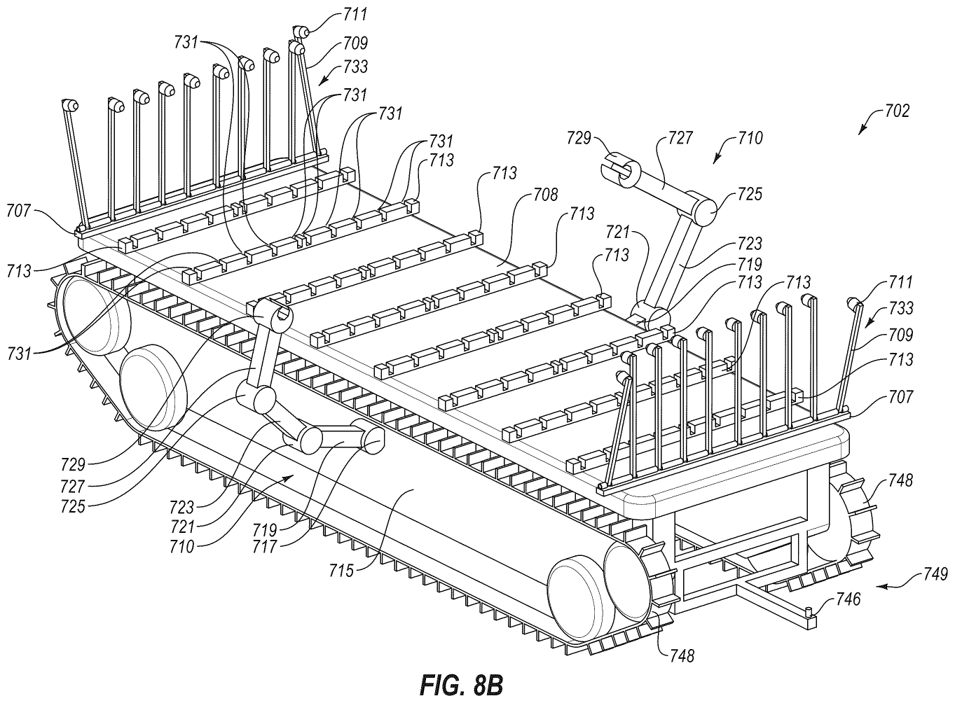

With combined reference to FIGS. 7-8B, the distribution device 702 may include a platform 708 that stores the PV modules 705a-b in a predetermined orientation. In some embodiments, the platform 708 may store the PV modules 705a-b in a vertical orientation such that a length of the given torque tube 116 extends substantially parallel to the ground surface or a surface of the distribution device 702 and such that a length of the given PV panels extends substantially normal to the ground surface or the surface of the distribution device 702.

The platform 708 may include retention devices 713 that facilitate the predetermined orientation of the PV modules 705a-b, prevent the PV modules 705a-b from moving relative to the platform 708, or both. The retention device 713 may define openings 731 (shown in FIGS. 8A and 8B) configured to receive edges of the PV modules 705a-b to facilitate the predetermined orientation or prevent the PV modules 705a-b from moving. The openings 731 of a single retention device 713 are numbered in FIGS. 8A and 8B for ease of illustration.

The retention device 713 is shown in FIGS. 8A and 8B as defining openings 731 for example purposes. However, the retention device 713 may include any appropriate configuration to facilitate the predetermined orientation of the PV modules 705a-b, prevent the PV modules 705a-b from moving relative to the platform 708, or both.

The platform 708 may include retention arms 733 that selectively interface with the PV modules 705a-b to facilitate the predetermined orientation. In addition, the retention arms 733 may prevent the PV modules 705a-b from moving relative to the platform 708 or falling over. Only a single pair of retention arms 733 are numbered in FIGS. 7-8B for ease of illustration. In addition, the retention arms 733 may selectively interface with the PV modules 705a-b to facilitate removal of the PV modules 705a-b from the platform 708. For example, the retention arms 733 may move such that they no longer interface with the PV modules 705a-b to permit the PV modules 705a-b to be removed from the platform 708. In some embodiments, the retention arms 733 may selectively interface with ends of corresponding torque tubes 116.

The retention arm 733 may include a base portion 707, an extension member 709, and an engagement flange 711. The base portion 707 may be coupled to the platform 708 and the extension member 709 may be operatively coupled to the base portion 707. The engagement flange 711 may be coupled to a distal end of the extension member 709. The engagement flange 711 may selectively interface with the PV modules 705a-b. For example, the engagement flange 711 may be sized and shaped so as to be received by ends of given torque tubes 116 of the PV modules 705a-b.

The extension member 709 may pivot around the base portion 707 to facilitate movement of the engagement flange 711 along an arc around the base portion 707 to facilitate the selective interface of the engagement flange 711 with the PV modules 705a-b. For example, the extension member 709 may pivot around the base portion 707 to move the engagement flange 711 along the arc to cause the engagement flange 711 to be received by the given torque tube 116 or remove the engagement flange 711 from the given torque tube 116.

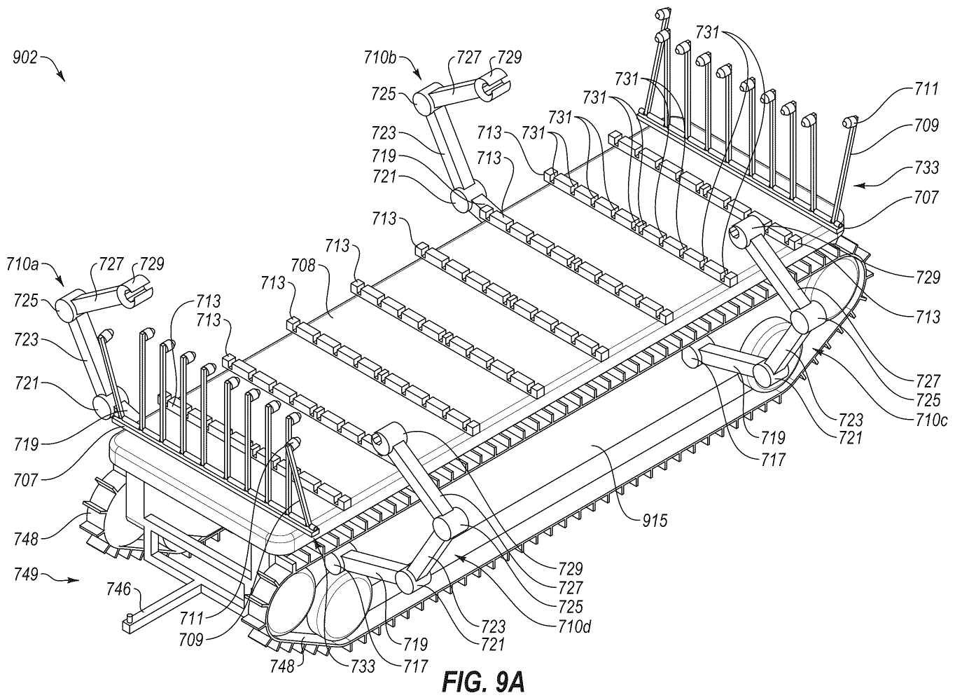

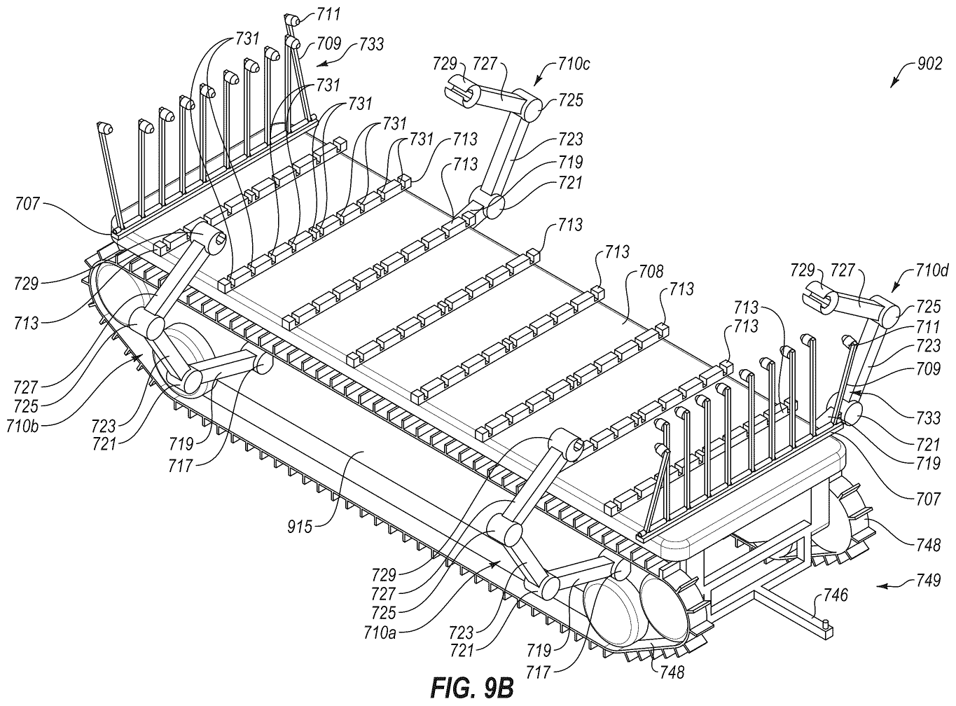

The distribution device 702 may include installation arms 710 configured to remove the PV modules 705a-b from the platform 708 and position the PV modules 705a-b proximate given support columns 114. The installation arms 710 may be configured to operate at the same time to remove and position the PV modules 705a-b at the same time as well. The installation arm 710 may be coupled to a given sidewall 715 of the platform 708. The distribution device 702 is illustrated as including two installation arms 710 coupled to opposite sidewalls 715 for example purposes. The distribution device 702 may include any appropriate number of installation arms 710 such as four as shown and described in more detail below in relation to FIGS. 9A and 9B.

The installation arm 710 may selectively interface with the torque tube 116 of the PV module 705a. In some embodiments, the installation arm 710 may selectively interface with a central point of the torque tube 116 of the PV module 705a. Alternatively, the installation arm 710 may interface with a point offset from a center of the torque tube 116 of the PV module 705a.

The installation arm 710 may retrieve the PV module 705a from the platform 708. In addition, the installation arm 710 may position the PV module 705a relative to given support columns 114, a given PV module 704, or both. The installation arm 710 may position the PV module 705a to permit the user 106 to couple the PV module 705a to the given support columns 114, the given PV module 704, or both. In some embodiments, the installation arm 710 autonomously retrieves the PV module 705a from the platform 708 and positions the PV module 705a based on an installation instruction. In some embodiments, the installation arm 710 may receive the installation instruction from a remote control operated by the user 106.

In some embodiments, the installation arm 710 may be guided by the user 106 using the remote control to interface and move the PV module 705a (e.g., the installation instruction may include directional commands provided by the user 106).

When the PV module 705a is coupled to the given support columns 114, the given torque tube 116, or both, the installation arm 710 may release the PV module 705a. The installation arm 710 may release the PV module 705a based on an installation complete instruction. The installation arm 710 may receive the installation complete instruction from the remote control operated by the user 106. After releasing the PV module 705a, the vehicle 712 may move the distribution device 702 in a direction relative to the longitudinal axis of the PV modules 704 to position additional PV modules relative to different support columns 114.

As shown, the installation arm 710 includes a body joint 717, a first member 719, a first arm joint 721, a second member 723, a second arm joint 725, a third member 727, and an appendage member 729. The body joint 717 may be coupled to the sidewall 715. The first member 719 may be coupled to the body joint 717 and the fist arm joint 721. In addition, the second member 723 may be coupled to the first arm joint 721 and the second arm joint 725. Further, the third member 727 may be coupled to the second arm joint 725 and the appendage member 729.

The body joint 717 may pivot around a first axis to facilitate movement of the first member 719 along an arc around the first axis. The first arm joint 721 may pivot around a second axis to facilitate movement of the second member 723 along an arc around the second axis. The second arm joint 725 may pivot around a third axis to facilitate movement of the third member 727 along an arc around the third axis. The appendage member 729 may be configured to grab the given torque tube 116 of the PV module 705a and the body joint 717, the first arm joint 721, the second arm joint 725, or some combination thereof may pivot around the corresponding axes to permit the appendage member 729 to manipulate the PV module 705a.

With continued reference to FIGS. 7-8B, the distribution device 702 may include a hitch portion 746 configured to couple to the vehicle 712. In some embodiments, the vehicle 712 may include a trailer hitch 755 configured to interface with the hitch portion 746 to couple the distribution device 702 to the vehicle 712. In addition, the distribution device 702 may include a drive system 749. As shown in FIGS. 7-8B, the drive system 749 includes tracks 748. However, the drive system 749 may include other drive devices such as one or more wheels.

With reference to FIG. 7, the vehicle 712 as shown includes a drive system 753 that includes tracks 751. However, the drive system 753 may include other drive devices such as one or more wheels. The distribution device 702 and the vehicle 712 are shown in FIG. 7 as separate devices for example purposes. Alternatively, the distribution device 702 and the vehicle 712 may form a single body vehicle. The vehicle 712, the distribution device 702, or both may operate autonomously or semi-autonomously to position the PV modules to be installed within the installation site or move between the loading site and the installation site.

With continued reference to FIG. 7, the vehicle 712, the distribution device 702, or both may include a position detection system (not illustrated). The position detection system may detect a position of the vehicle 712, the distribution device 702, or both during movement. In some embodiments, the position detection system may detect the position of the vehicle 712, the distribution device 702, or both relative to a most recently installed PV module 704. Alternatively, the position detection system may detect the position of the vehicle 712, the distribution device 702, or both relative to the support columns 114 or any other appropriate solar component or landmark. The distribution device 702 may provide an alert indicating that the vehicle 712, the distribution device 702, or both are positioned relative to a subsequent location corresponding to where another PV module is to be installed.

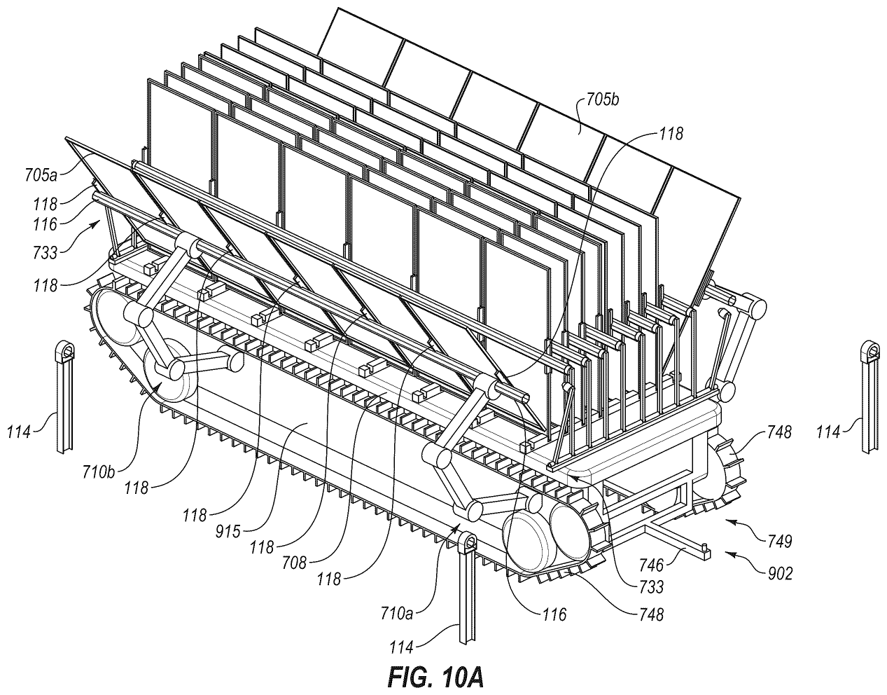

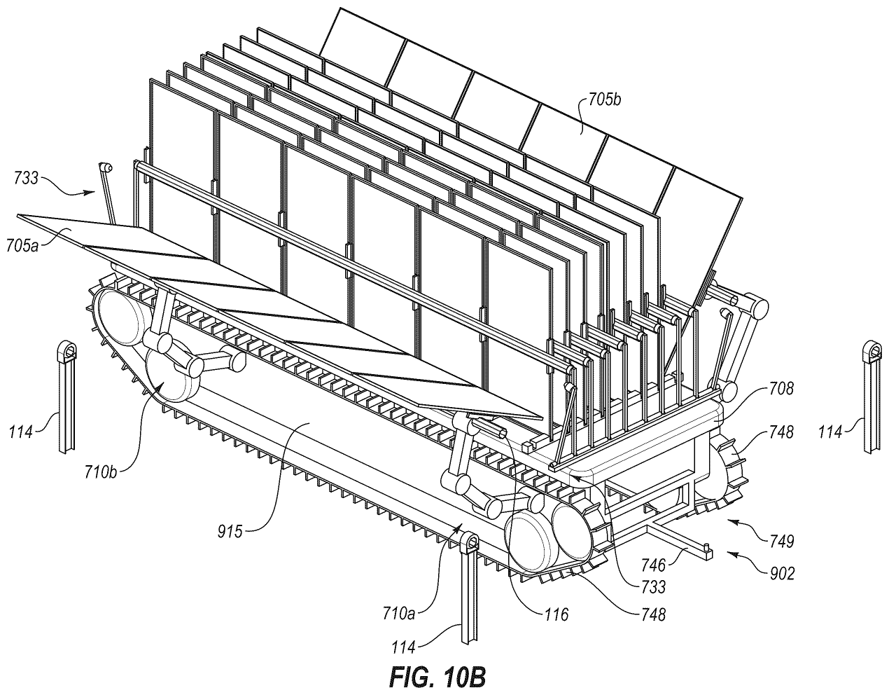

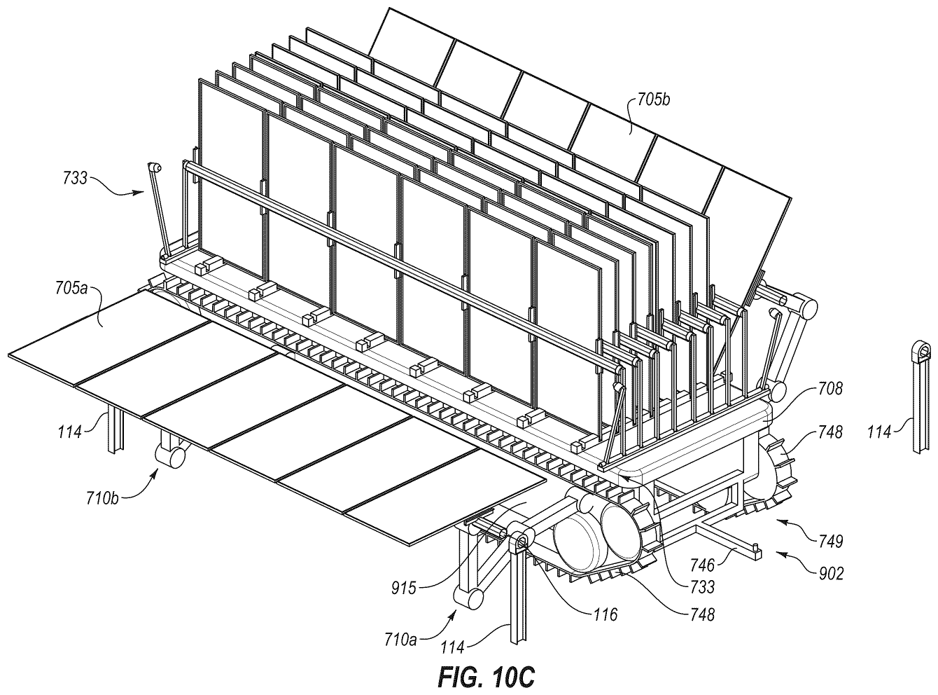

FIGS. 9A and 9B illustrate another example PV module distribution device 902 (generally referred to in the present disclosure as distribution device 902) configured to distribute PV modules (e.g., the PV modules 705a-b). The distribution device 902 may operate the same as or similar to the distribution device 702 of FIGS. 7-8B except that the distribution device 902 includes four installation arms 710a-d coupled to sidewalls 915 instead of two installation arms 710. The installation arms 710a-d may selectively interface with the central point, an end point, an intermediate point, or any other point of the given torque tube. An example of the installation arms 710a-b selectively interfacing with intermediate points of a given torque tube 116 is illustrated in FIGS. 10A-10C. Pairs of the installation arms 710a-d may operate in tandem to retrieve the PV modules from the platform 708 and position the PV modules proximate to given support columns. For example, the installation arms 710a-b may operate in tandem to retrieve the PV module 705a from the platform 708 and position the PV module 705a proximate given support columns 114 as illustrated and described in more detail below in relation to FIGS. 10A-10C.

With reference to FIGS. 10A-10C, the module distribution device 902 is shown with the installation arms 710a-b in different positions to move the PV module 705a from the platform to an installation position. The installation arms 710a-b are shown in an initial state in FIG. 10A and the PV module 705a is shown as already being removed from the platform 708 in FIG. 10A. In the initial state shown, the installation arms 710a-b may be transitioning to an intermediate state. The installation arms 710a-b are shown in the intermediate state in FIG. 10B. In the intermediate state shown, the PV module 705a is further removed from the platform 708 compared to the initial state. In addition, in the intermediate state shown, the installation arms 710a-b may be transitioning to an installation state or a final state to position the PV module 705a in the installation position as shown in FIG. 10C. In the installation position, the PV module 705a may be able to be attached to the corresponding support columns 114.

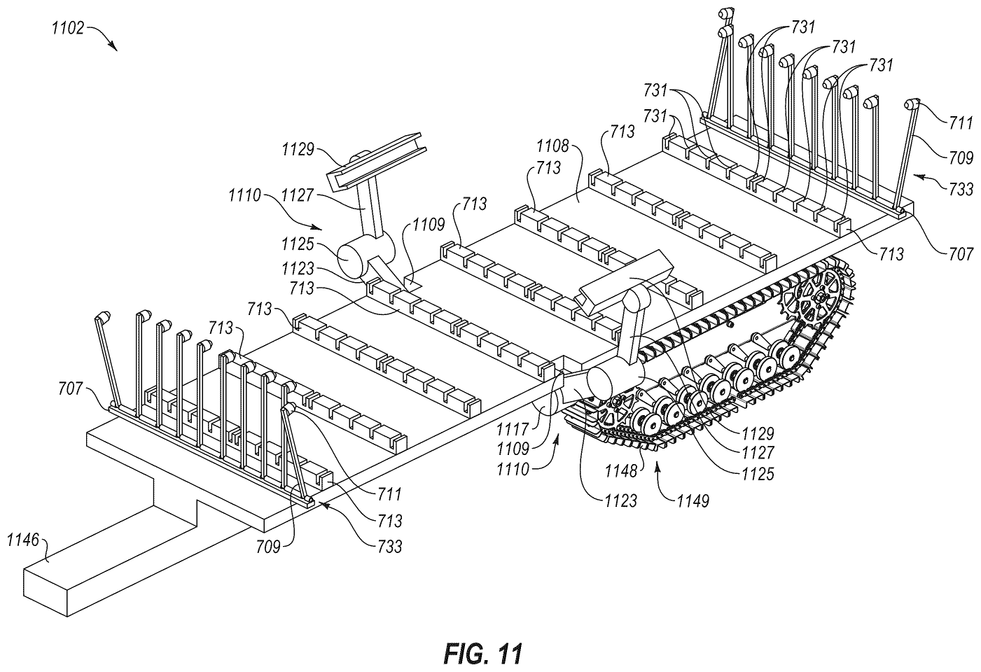

FIG. 11 illustrates another example PV module distribution device 1102 (generally referred to in the present disclosure as distribution device 1102). The distribution device 1102 may store and/or position the PV modules to facilitate distribution of the PV modules within the installation site and/or facilitate installation of the PV modules in a solar installation. The distribution device 1102 may operate the same as or similar to the distribution device 702 of FIGS. 7-8B except that the distribution device 1102 includes different installation arms 1110 and a different platform 1108.

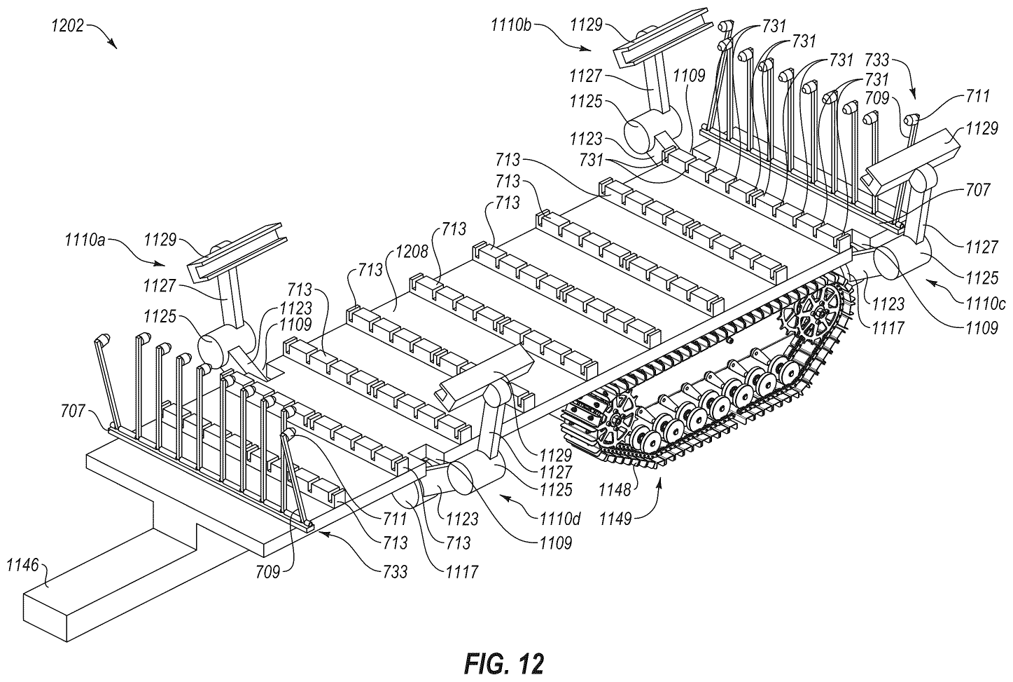

The platform 1108 may store the PV modules in a predetermined orientation. In some embodiments, the platform 1108 may store the PV modules in the vertical orientation. The installation arms 1110 may be configured to remove the PV modules from the platform 1108 and position the PV modules proximate given support columns. The installation arms 1110 may be configured to operate at the same time to remove and position the PV modules at the same time as well. The distribution device 1102 is illustrated as including two installation arms 1110 coupled to opposite sides of the platform 1108 for example purposes. The distribution device 1102 may include any appropriate number of installation arms 1110 such as four as shown and described in more detail below in relation to FIG. 12.

The installation arm 1110 may selectively interface with the torque tube of the PV module. In some embodiments, the installation arm 1110 may selectively interface with a central point of the torque tube of the PV module. Alternatively, the installation arm 1110 may interface with a point offset from a center of the torque tube of the PV module.

The installation arm 1110 may retrieve the PV module from the platform 1108. In addition, the installation arm 1110 may position the PV module relative to given support columns, a given PV module, or both. The installation arm 1110 may position the PV module to permit users to couple the PV module to the given support column, the given PV module, or both. In some embodiments, the installation arm 1110 autonomously retrieves the PV module from the platform 1108 and positions the PV module based on an installation instruction. In some embodiments, the installation arm 1110 may receive the installation instruction from a remote control operated by the user. In some embodiments, the installation arm 1110 may be guided by the user using the remote control to interface and move the PV module (e.g., the installation instruction may include directional commands provided by the user).

When the PV module is coupled to the given support columns, the given torque tube, or both, the installation arm 1110 may release the PV module. The installation arm 1110 may release the PV module based on an installation complete instruction. The installation arm 1110 may receive the installation complete instruction from the remote control operated by the user.

As shown, the installation arm 1110 includes a body joint 1117, a first member 1123, an arm joint 1125, a second member 1127, and an appendage member 1129. The body joint 1117 may be coupled to the sidewall of the platform 1108. The first member 1123 may be coupled to the body joint 1117 and the arm joint 1125. In addition, the second member 1127 may be coupled to the arm joint 1125 and the appendage member 1129.

The body joint 1117 may pivot around a first axis to facilitate movement of the first member 1123 along an arc around the first axis. The arm joint 1125 may pivot around a second axis to facilitate movement of the second member 1127 along an arc around the second axis. The appendage member 1129 may pivot around a third axis to facilitate movement of the appendage member along an arc around the third axis. The appendage member 1129 may be configured to grab the given torque tube of the PV module and the body joint 1117, the arm joint 1125, the appendage member 1129, or some combination thereof may pivot around the corresponding axes to permit the appendage member 1129 to manipulate the PV module.

The platform 1108 may define openings 1109 positioned proximate the installation arms 1110. The openings 1109 may be configured to at least partially receive the first member 1123 to permit the appendage member 1129 to reach further across the platform 1108.

The distribution device 1102 may include a hitch portion 1146 configured to couple to a trailer hitch of a vehicle. In addition, the distribution device 1102 may include a drive system 1149. As shown in FIG. 11, the drive system 1149 includes tracks 1148. However, the drive system 1149 may include other drive devices such as one or more wheels.

FIG. 12 illustrates yet another example PV module distribution device 1202 (generally referred to in the present disclosure as distribution device 1202) configured to distribute PV modules (e.g., the PV modules 705a-b). The distribution device 1202 may operate the same as or similar to the distribution device 1102 of FIG. 11 except that the distribution device 1202 includes four installation arms 1110 instead of two installation arms 1110 and a different platform 1208. The platform 1208 may define four openings 1109 for the four installation arms 1110 rather than just two openings.

The installation arms 1110 may selectively interface with the central point, an end point, an intermediate point, or any other point of the given torque tube. Pairs of the installation arms 1110 may operate in tandem to retrieve the PV modules from the platform 1208 and position the PV modules proximate to given support columns. For example, the installation arms 1110 may operate in tandem to retrieve the PV module from the platform 1208 and position the PV module proximate given support columns 114.

1. A photovoltaic (PV) module distribution device comprising:
a platform configured to store a plurality of PV modules in a pre-determined orientation, each of the PV modules comprising a plurality of solar components that are pre-assembled to form a corresponding PV module; and
an installation arm configured to:
retrieve a PV module of the plurality of PV modules from the platform; and
position the PV module proximate a support column physically located proximate the PV module distribution device to permit a user to attach the PV module to the support column.

2. The PV module distribution device of claim 1, wherein:
the PV module comprises a first PV module of the plurality of PV modules and the support column comprises a first support column;
the installation arm comprises a first installation arm coupled to a first side of the platform; and
the PV module distribution device further comprises a second installation arm coupled to a second side of the platform that is opposite the first side of the platform, the second installation arm configured to:
retrieve a second PV module of the plurality of PV modules from the platform; and
position the second PV module proximate a second support column physically located proximate the PV module distribution device to permit the user to attach the second PV module to the second support column.

3. The PV module distribution device of claim 2, wherein the second installation arm is configured to operate at the same time as the first installation arm.

4. The PV module distribution device of claim 1, wherein:
the PV module comprises a torque tube; and
the installation arm is configured to selectively interface with the torque tube to retrieve the PV module from the platform.

5. The PV module distribution device of claim 1, wherein the installation arm is configured to:
retrieve the PV module autonomously based on an installation instruction; and
autonomously release the PV module based on an installation complete instruction.

6. The PV module distribution device of claim 1, wherein the platform comprises a retention device configured to:
facilitate the pre-determined orientation of the plurality of PV modules; and
prevent the plurality of PV modules from moving relative to the platform.

7. The PV module distribution device of claim 6, wherein the retention device defines a plurality of openings configured to receive edges of the plurality of PV modules to facilitate the pre-determined orientation the plurality of PV modules.

8. The PV module distribution device of claim 1, wherein the platform comprises a plurality of retention arms configured to selectively interface with the plurality of PV modules to:
facilitate the pre-determined orientation of the plurality of PV modules; and
facilitate the retrieval of the plurality of PV modules from the platform.

9. The PV module distribution device of claim 8, wherein each of the plurality of retention arms comprises:
a base portion coupled to the platform;
an extension member coupled to the base portion; and
an engagement flange coupled to a distal end of the extension member, the engagement flange being configured to selectively interface with an individual PV module of the plurality of PV modules to:
facilitate the pre-determined orientation of the individual PV module; and
facilitate the retrieval of the individual PV module from the platform.

10. The PV module distribution device of claim 1 comprising a hitch portion configured to couple to a vehicle to permit the PV module distribution device to be moved by the vehicle within an environment.

11. The PV module distribution device of claim 10 comprising a position detection system configured to detect a position of the PV module distribution device relative to the support column when the vehicle moves the PV module distribution device.

12. A photovoltaic (PV) module distribution device comprising:
a platform configured to store a plurality of PV modules in a pre-determined orientation, each of the PV modules comprising a plurality of solar components that are pre-assembled to form a corresponding PV module; and
a first installation arm and a second installation arm, wherein the first installation arm and the second installation arm are configured to selectively interface with different portions of a PV module of the plurality of PV modules to:
retrieve the PV module from the platform; and
position the PV module proximate a support column physically located proximate the PV module distribution device to permit a user to attach the PV module to the support column.

13. The PV module distribution device of claim 12, wherein:
the PV module comprises a first PV module of the plurality of PV modules and the support column comprises a first support column;
the first installation arm and the second installation arm are coupled to a first side of the platform; and
the PV module distribution device further comprises a third installation arm and a fourth installation arm, wherein the third installation arm and the fourth installation arm are coupled to a second side of the platform that is opposite the first side of the platform and the third installation arm and the fourth installation arm are configured to selectively interface with different portions of a second PV module of the plurality of PV modules to:
retrieve the second PV module from the platform; and
position the second PV module proximate a second support column physically located proximate the PV module distribution device to permit the user to attach the second PV module to the second support column.

14. The PV module distribution device of claim 12, wherein:
the PV module comprises a torque tube; and
the first installation arm is configured to selectively interface with a first portion of the torque tube and the second installation arm is configured to selectively interface with a second portion of the torque tube to retrieve the PV module from the platform.

15. The PV module distribution device of claim 12, wherein the platform comprises a retention device configured to:
facilitate the pre-determined orientation of the plurality of PV modules; and
prevent the plurality of PV modules from moving relative to the platform.

16. The PV module distribution device of claim 15, wherein the retention device defines a plurality of openings configured to receive edges of the plurality of PV modules to facilitate the pre-determined orientation the plurality of PV modules.

17. The PV module distribution device of claim 12, wherein the platform comprises a plurality of retention arms configured to selectively interface with the plurality of PV modules to:
facilitate the pre-determined orientation of the plurality of PV modules; and
facilitate the retrieval of the plurality of PV modules from the platform.

18. The PV module distribution device of claim 17, wherein each of the plurality of retention arms comprises:
a base portion coupled to the platform;
an extension member coupled to the base portion; and
an engagement flange coupled to a distal end of the extension member, the engagement flange being configured to selectively interface with any individual PV module of the plurality of PV modules to:
facilitate the pre-determined orientation of the individual PV module; and
facilitate the retrieval of the individual PV module from the platform.

19. The PV module distribution device of claim 12 comprising a hitch portion configured to couple to a vehicle to permit the PV module distribution device to be moved by the vehicle within an environment.

20. The PV module distribution device of claim 19 comprising a position detection system configured to detect a position of the PV module distribution device relative to the support column when the vehicle moves the PV module distribution device.
